(19) United States
(12) Patent Application Publication
(10) Pub. No.: US 2004/0248688 A1
(43) Pub. Date: Dec. 9, 2004

(54) Oscillating internal-meshing planetary gear system and method for improving the durability thereof

(76) Inventor: Masahiro Shimada, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/812,305

(22) Filed: Mar. 30, 2004

(30) Foreign Application Priority Data
Mar. 31, 2003 (JP) P2003-095054

(51) Int. Cl. F16H 57/04; F16H 23/00

(52) U.S. Cl. 475/159; 475/163

(57) ABSTRACT

In the oscillating internal-meshing planetary gear system of the present invention, a space formed between a external gear (52) and a internal gear (8) is filled up with a grease (14), which contains base oil whose kinetic viscosity is equal to or higher than 10 mm²/s at 100° C. and lithium complex thickener synthesized from adipic acid. Such construction of the oscillating internal-meshing planetary gear system of the present invention provides a power transmission system using a trochoidal tooth profile gear and a circular-arc tooth profile gear that enables to realize a long life and keeping a high efficiency, even without applying grease containing sodium nitrite.

### BACKGROUND OF THE INVENTION

1. The Field of the Invention

The present invention relates to a oscillating internal-meshing planetary gear system and method for improving the durability thereof, wherein the system comprises a conversion mechanism from sliding contacts to rolling contacts in respect to gear teeth meshing through internally-meshing a trochoidal tooth profile gear and a circular-arc tooth profile gear with a oscillating motion.

2. Related Background Art

A number of conventional power transmission systems by which an input rotation of a motor, etc., is transmitted to mating parts either with reduction or speedup are known. In such applications, power transmission systems by using trochoidal tooth profile gears and circular-arc tooth profile gears are known. In applications of such systems, one of the cases is that an external gear with trochoidal tooth profile is internally-meshed oscillatingly with an internal gear with circular-arc tooth profile (pin), and another case is that an internal gear with trochoidal tooth profile is internally-meshed oscillatingly with an external gear with circular-arc tooth profile. In these power transmission systems, the power is transmitted by rolling contacts between the trochoidal tooth profile gears and the circular-arc tooth profile gears. However slippage is apt to occur between these gears due to the constitution of these tooth profiles. For this reason, specific grease is required for lubricating the trochoidal tooth profile gears and the circular-arc tooth profile gears other than those used for involute tooth profile gears which transmit power mostly through sliding contacts.

As a suitable example of grease for the trochoid and the circular-arc tooth profile gears, for example, such grease (Albania-RA, manufactured by Showa Shell Sekiyu K.K.) that is noted in the laid-open patent application 2001-173744 has been conventionally used. The reason for use is that the Albania-RA grease (manufactured by Showa Shell Sekiyu K.K.) prevents the meshing portion of the trochoidal tooth profile and the circular-arc tooth profile from being damaged for a longer time, in the order of 2 to 10 times, without interrupting the operation as compared to other types of grease.

### SUMMARY OF THE INVENTION

The Albania-RA grease includes sodium nitrite as a antirust. The inventor has found the sodium nitrite causing the life of the trochoid and the circular-arc tooth profile portions to be extended.

Sodium nitrite, however, is believed to generate a carcinogenic nitrosamine in reaction with certain chemical substances and therefore it will probably be tightly regulated on its use mainly in Europe in the near future. In addition, due to its own toxicity, sodium nitrite is listed in the wastewater restrictions under the Water Pollution Control Law in Japan. Moreover, some municipalities set the upper limit of nitrite-nitrogen contained in such as sodium nitrite as the quality standard of wastewater discharged into the public sewerage or the river-basin sewerage from specific business establishments. Therefore, use of grease containing such substance as sodium nitrite is unfavorable in view of public health and environmental protection.

In view of the foregoing problems of prior art, it is an object of the present invention is to provide a power transmission system using the trochoidal tooth profile gears and the circular-arc tooth profile gears which enables a sufficient long life and a sufficient high efficiency without using grease containing sodium nitrite and to provide a method for improving the durability of such mechanism.

The inventor conducted diligent studies in order to achieve the above-mentioned object and, as a result, have found that a longer life of the trochoid and the circular-arc tooth profile gears is achievable with application of certain grease which contains the chemical substance prepared from specific ingredients and has a specific characteristics, instead of applying grease containing sodium nitrite, and thus the present invention was achieved.

The power transmission system of the present invention is A oscillating internal-meshing planetary gear system, comprising; an external gear; and an internal gear of which the number of teeth is slightly different from the external gear, wherein: the oscillating rotation of either the external gear or the internal gear relative to the mating gear reduces a input shaft rotation and a output reduced speed is taken off from a output shaft; either the external gear or the internal gear has trochoidal tooth profile and the mating gear has circular-arc tooth profile; and a space formed between the external gear and the internal gear is filled up with a grease which contains at least a base oil having kinetic viscosity being not less than 10 mm²/s at 100° C. and a lithium complex thickener synthesized from adipic acid.

As the oscillating internal-meshing planetary gear system is provided with such constitution as aforementioned, it can achieve the same or a longer life as a system which uses the grease containing sodium nitrite. Although its function has not been identified yet, it is deemed to be a cause as follows, but the functions are not limited as such.

The base oil with relatively high kinetic viscosity at high temperature forms a thick film to protect the tooth surface from oxidization. In this situation the lithium complex synthesized from adipic acid, taking advantage of its own characteristic of fabric construction, guards the base oil. Thereby a sufficiently thick film of the base oil due to the high viscosity of the base oil is maintained even with gear contact and moreover with friction.

In addition, the oscillating internal-meshing planetary gear system of the present invention is enabled to operate for a longer time by adjusting the kinetic viscosity of base oil not less than 50 mm²/s at 40° C., and for further extended time by adjusting that not less than 100 mm²/s.

Further, the present invention provides method for improving the durability of a oscillating internal-meshing planetary gear system, the system comprising an external gear and an internal gear of which the number of teeth is slightly different from the external gear, either the external gear or the internal gear having trochoidal tooth profile and the mating gear having circular-arc tooth profile, the oscillating rotation of either the external gear or the internal gear relative to the mating gear reducing a input shaft rotation and a output reduced speed being taken off from a output shaft, the method comprising a step of filling up a space formed between the external gear and the internal gear with a grease containing at least a base oil having kinetic viscosity not less than 10 mm²/s at 100° C. and lithium complex thickener synthesized from adipic acid.

And, for improving durability of the oscillating internal-meshing planetary gear system, a use of the base oil having the kinetic viscosity of 50 mm²/s or higher at 40° C. is preferred, and the base oil having the kinetic viscosity of 100 mm²/s or higher is further preferable.

### BRIEF DESCRIPTION OF THE DRAWINGS

FIG. 1 illustrates a side sectional view of the oscillating internal-meshing planetary gear system of an enbodiment of the present invention.

FIG. 2 illustrates the II-II sectional view of the FIG. 1 of the oscillating internal-meshing planetary gear system.

### DESCRIPTION OF THE PREFERRED EMBODIMENTS

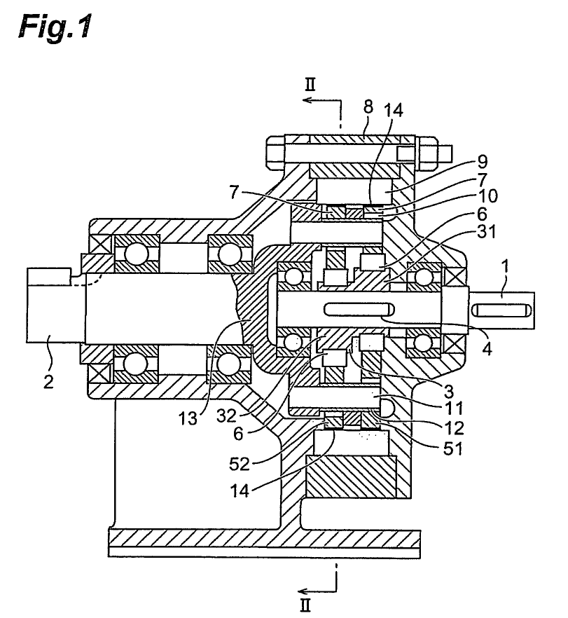

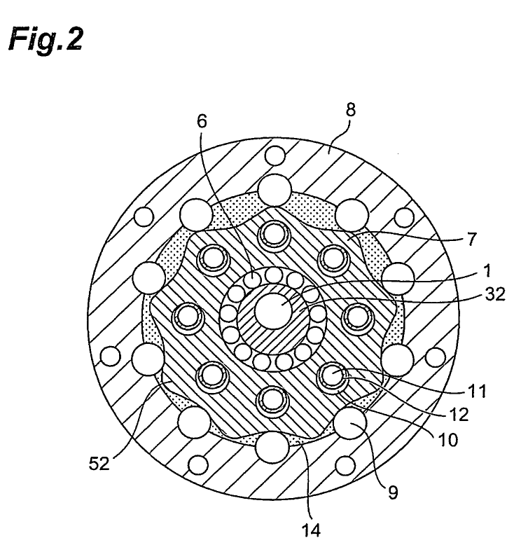

Referring to the attached drawings, a preferred embodiment of the present invention is explained in detail hereinafter. FIG. 1 illustrates a side sectional view of a preferred embodiment for the oscillating internal-meshing planetary gear system. FIG. 2 illustrates the II -II sectional view of the FIG. 1 of the oscillating internal-meshing planetary gear system.

A hollow eccentric body shaft 3 is fixed to an input rotation shaft 1 by a key (not shown) and a key groove 4; two eccentric pieces 31 and 32 are mounted on the eccentric body shaft 3; two external gears 51 and 52 are fitted to the eccentric pieces 31 and 32 respectively with 180 degrees phase difference from each other via rollers 6; the external gears 51 and 52 are provided with external teeth 7 having trochoid profile. Internal gear 8 also forms the outer casing and is set to be stationary in this embodiment; the internal gear 8 has circular-arc tooth profiles, which is formed by outer pins 9, and mesh with the external teeth 7 of the external gears 51 and 52; the outer pins 9 can also adopt a constitution of outer rollers. Inner pin holes 10 are formed in the external gears 51 and 52; inner pins 11 are loose-fitted in the inner pin holes 10; inner roller 12 is loose-fitted on the outer circumference of the inner pin 11; one end of the inner pin 11 is tight-fitted into inner pin holding flange 13; the inner pin holding flange 13 is formed as an integral part with output rotation shaft 2. In this embodiment, the inner roller 12 can be eliminated.

In this oscillating internal-meshing planetary gear system, one rotation of the input rotation shaft 1 makes one rotation of the eccentric parts 31 and 32, whereas the external gears 51 and 52 are rotated in oscillating motion with a specific oscillating rotation radius because the rotation of the external gears 51 and 52 are restricted by the inner pin holes 10 and the inner pins 11. Therefore, if the difference between the number of teeth on the external gear 51 (and 52) and the number of outer pins 9 (the number of teeth on the internal gear 8) is one, then one revolution of the input shaft 1 causes one-tooth displacement of meshing (divergence) between the external gear teeth 7 on the external gear 51 (and 52) and the outer pins 9 which are the inner teeth on the internal gear 8.

Such displacement of gear meshing causes not only rolling contact but also sliding contact between the inner teeth 7 and the outer pins 9.

It shall be noted that one rotation of the input rotation shaft 1 is reduced to the rotation of 1/number of teeth on the external gear 51 (and 52), which is transmitted to the output rotation shaft 2 via the inner pins 11.

The oscillating internal-meshing planetary gear system of this embodiment is characterized in that the grease 14 which contains at least base oil and thickener therein is filled up the space between the external gear 51 (and 52) and the internal gear 8 (between the outer pins 9 forming the circular-arc tooth profile and the external gear teeth 7 forming the trochoidal tooth profile), wherein lithium complex is contained as the thickener and dibasic acid as the base material of the thickener is adipic acid, wherein the base oil has the kinetic viscosity of 10 mm²/s or higher at 100° C.

Here, the grease is principally determined to be either solid or semisolid lubricant obtained by blending base oil with thickener.

Any type of base oil can be used if it is usually contained in grease provided that the kinetic viscosity is equal to or higher than 10 mm²/s at 100° C. The temperature in the gear contact areas of the oscillating internal-meshing planetary gear system will rise as high as 93° C. due to the friction between meshing gear tooth profiles in operation, consequently it is believed that forming of specified thickness film on the tooth surface will become difficult if the kinetic viscosity around 100° C. is exceptionally low. Therefore it is impossible to achieve a long life oscillating internal-meshing planetary gear system by using base oil whose kinetic viscosity is lower than 10 mm²/s at 100° C. Further, the base oil having the kinetic viscosity of 50 mm²/s or higher at 40° C. is preferred, and that of 100 mm²/s or higher is further preferable.

As the examples of the base oil related to the present invention, anyone of the below-mentioned base oil having the kinetic viscosity being 10 mm²/sec or higher at 100° C. may be included in a list, i.e. paraffinic and naphthenic mineral oils, synthetic oils such as synthetic hydrocarbon oil, phenyl ether, polyglycol, diester, polyolester, silicone oil and fluorinated oil, biodegradable oil such as vegetable oil.

Thickener is believed to form three-dimensional fabric constructions in the base oil, in the gaps of which the base oil is retained and thereby forming grease as a solid or a semisolid state. As the thickener added to grease in general, lithium soap, lithium complex, calcium soap, calcium complex, aluminum complex, urea compound and so on are selected; whereas lithium complex shall be used for the oscillating internal-meshing planetary gear system of the present invention. If a thickener other than the lithium complex is used, the oscillating internal-meshing planetary gear system can not achieve the desired length of service due to operational interruption caused by teeth profile damage such as pitting in relatively short time of operation.

Lithium complex is usually made by a chemical reaction of lithium hydrate with a mixture of fatty acid and dibasic acid. In making the lithium complex relating to the present invention, adipic acid shall be used as the dibasic acid for basic material. If the grease containing any of lithium complex synthesized from any dibasic acids other than adipic acid, such as succinic acid, glutaric acid, pimelic acid, suberic acid, or azelaic acid, the oscillating internal-meshing planetary gear system can not achieve the purpose of the present invention due to the operational interruption caused by teeth profile pitting in relatively short time of operation.

It is noted that a fatty acid to synthesize lithium complex can be any applicable one without any specific constraint if it has been conventionally used as raw material for lithium complex synthesizing.

The oscillating internal-meshing planetary gear system of the present invention allows the applicable grease to contain other substances normally used as its additives. Such additives include antioxidant, dispersant, abrasion-resistant material, anti-corrosion material, high-pressure resistant material.

Sodium nitrite can be used as additive to the grease relating to the present invention, but it is unfavorable from the viewpoint of the public health and environmental protection, as aforementioned.

While the content percentage of each additive is not specified, 80 to 85% of base oil, 10 to 15% of thickener, and 5 to 10% of other additives are preferable to take advantage of synergistic effect of the base oil and the thickener, and thereby achieve an even longer life and a higher efficiency.

Meanwhile, in this embodiment, the grease 14 is at least filled up in the gap between the internal gear 8 and the external gears 51, and 52, but it can be applied to other places such as the gap between the casing and the output rotation shaft 2, and also each bearing. It is further possible to fill the grease 14 in all the gaps within the oscillating internal-meshing planetary gear system.

The above-described constitution of the oscillating internal-meshing planetary gear system of the present invention can accomplish and maintain a long life and a high efficiency without adding sodium nitrite to the grease.

In addition, A method for improving the durability of the oscillating internal-meshing planetary gear system relating to this embodiment is characterized in that the grease 14 as described above is filled up the space between the internal gear 8 and the external gears 51, and 52. Compared to a system with conventional grease filled up in the equivalent area, the constitution of the invention greatly reduces abrasion or damage in contacting area between the outer pins 9 and the external gear teeth 7, and thereby achieves a long life of the external gears 51 and 52, and the internal gear 8, resulting in great improvement of durability of the oscillating internal-meshing planetary gear system itself.

It is noted that, in the durability improvement methods, the grease 14 may also be filled in other places, in addition to the gap between outer pins 9 and external gear 7 formed by the trochoid gear profile, such as the gap between the casing and the output rotation shaft 2, and each bearing. It is further possible to fill all the gaps inside the oscillating internal-meshing planetary gear system with the grease 14. With such application the durability improvement method not only enables a longer life of each gear but also improves the durability of friction portion and contacting portion of bearings, resulting in even longer life of the oscillating internal-meshing planetary gear system as a whole.

And, in the durability improvement methods, since the kinetic viscosity of the grease 14 is relatively high, leakage of the grease through gaps existing in the oscillating internal-meshing planetary gear system tends to be less than conventional lubricants and in this context the durability of the oscillating internal-meshing planetary gear system can be improved.

Further, it is advisable to monitor leakage of the grease 14 by using measurement instrument such as a level gauge installed in the casing, or by an analyzer installed in the drain tank or the like collecting waste fluid or oil for measuring concentrations of specific substances such as adipic acid. Through such methods, the grease 14 can be replenished as appropriate, and thereby the durability of the oscillating internal-meshing planetary gear system is further improved.

[Examples of the Embodiment(s)]

The invention will be further described in detail referring the embodiments. The invention, however, is not limited to these embodiments.

(Embodiment 1)

First, in this embodiment of the oscillating internal-meshing planetary gear system, components other than the grease were the components of Cyclo (registered trademark) Reducer which the applicant of the present invention presently places on the market. As the grease making up the present invention, ExonMobile Templex N2 was used between the trochoidal tooth profile on the external gear and the outer pins on the internal gear of this Cyclo (registered trademark) Reducer. As shown in Table 1, this grease contains a lithium complex thickener made from adipic acid and has the kinetic viscosity (based on JIS K2283; the same reference below) of 11.9 mm²/s at 100° C. and 111 m²/s at 40° C. The base oil was paraffin mineral oil both for the embodiment and the comparative examples.

TABLE 1

| | Embodiment | Comparison | Comparison | Comparison | Comparison | Comparison | Comparison | Comparison |
|---|---|---|---|---|---|---|---|---|
| | No. 1 | No. 1 | No. 2 | No. 3 | No. 4 | No. 5 | No. 6 | No. 7 |
| Thickener | Lithium | Lithium | Lithium | Lithium | Lithium | Lithium | Lithium | Lithium |
| | complex | complex | complex | complex | soap | soap | soap | soap |
| Dibasic acid | Adipic acid | Adipic acid | Azelaic | Dibasic | — | — | — | — |
| | | | acid | acid other | | | | |
| | | | | than adipic | | | | |
| | | | | acid | | | | |
| Base oil | 111 | 38.64 | 46.2 | 110 | 130 | 38.64 | 38.64 | 130 |
| viscosity at | | | | | | | | |
| 40° C. | | | | | | | | |
| Base oil | 11.9 | 6.155 | 6.6 | 12 | 12.2 | 6.155 | 6.155 | 12 |
| viscosity at | | | | | | | | |
| 100° C. | | | | | | | | |
| Additives | Anti- | Anti- | Anti- | Anti- | Anti- | Anti- | Anti- | Anti- |
| | oxidant | oxidant | oxidant | oxidant | oxidant | oxidant | oxidant | oxidant |
| | — | Dispersant | — | Anti- | Dispersant | Dispersant | Dispersant | Anti- |
| | | | | corrosion | | | | corrosion |
| | — | Anti- | — | — | Abrasion- | Anti- | Anti- | — |
| | | corrosion | | | resistant | corrosion | corrosion | |
| | — | Naphthenic | — | — | Oiliness | Special | Special | — |
| | | acid | | | improver | sulfurous | sulfurous | |
| | | | | | | high | high | |
| | | | | | | pressure | pressure | |
| | | | | | | resistant | resistant | |
| | — | Sodium | — | — | | Naphthenic | — | — |
| | | borate | | | | acid | | |
| Continuous | Over 2000 | 800 | 380 | 700 | 300 | 250 | 230 | 700 |
| operation | | | | | | | | |
| time (hour) | | | | | | | | |

In the above table, the base oil viscosity denotes the kinetic viscosity of the base oil whose unit is mm²/s.

(Comparison No.1)

In all comparison examples, components of Cyclo (registered trademark) Reducer which the applicant of the present invention presently places on the market were used other than the grease. Commercially available grease was used for all the comparison examples and the grease used contains none of the materials specific to the present invention.

In the comparison No.1, whereas the grease applied to the space between the trochoid gear profile on the external gear and the outer pins of the internal gear in the Cyclo (registered trademark) Reducer contained a lithium complex thickener made from adipic acid as base material, the kinetic viscosity of the base oil was 6.155 mm²/s at 100° C. and 38.64 m²/s at 40° C. which were lower than those of the grease relating to the present invention.

(Comparison No.2)

In the comparison No.2, the grease applied to the space between the trochoid gear profile on the external gear and the outer pins of the internal gear in the Cyclo (registered trademark) Reducer contained a lithium complex thickener made from azelaic acid as base material, and the kinetic viscosity of the base oil was lower at both 100° C. and 40° C. as compared to those of the grease relating to the present invention.

(Comparison No.3)

In the comparison No.3, the grease which contained a lithium complex thickener made from dibasic acid other than adipic acid was adopted to fill in the space between the trochoid gear profile on the external gear and the outer pins of the internal gear in the Cyclo (registered trademark) Reducer, whereas the kinetic viscosity of the base oil was within the range of the present invention both at 100° C. and 40° C.

(Comparison Numbers 4 through 7)

In the comparison numbers 4 through 7, the grease which contained a lithium soap thickener was adopted in the space between the trochoid gear profile on the external gear and the outer pins of the internal gear in the Cyclo (registered trademark) Reducer.

<Long Term Durability Running Test>

A series of long term durability running test of the aforementioned embodiment number 1 and the comparisons numbers 1 through 7 for the oscillating internal-meshing planetary gear system were conducted in the ambient temperature and under the uniform load conditions set for the tests and evaluations (prescribed torque, number of rotations, load-application method, and loading equipment).

The oscillating internal-meshing planetary gear system employing the grease containing sodium nitrite as additive (Albania Grease RA, manufactured by Showa Shell Sekiyu K.K.), which the inventor of the present invention found to be durable uniquely among the conventional grease applicable to the gear tooth profile portion of the oscillating internal-meshing planetary gear system, could be continuously operative for 2000 hours under the conditions described above. Therefore in this durability tests also, it was concluded that the capability of continuous operation more than 2000 hours was to be the evidence of durability, i.e., a long life.

Table 1 indicates the testing results. No serious damage to interrupt the operation was observed on the gear profile of the oscillating internal-meshing planetary gear system according to the embodiment number 1 after over 2000 hours continuous running test. On the contrary, any of those comparison examples did not reach 2000 hours continuous running operation, far from that, tooth surfaces damage (pitting) and/or braking in bearings occurred, resulting in a discontinued operation in less than 1000 hours, a half of the 2000 hours operation.

Although this specification does not explain in detail, using lithium soap as the thickener, thirty five types of the oscillating internal-meshing planetary gear systems were tested for durability adopting various grease containing a variety of additives, and none of the cases reached 2000 hours continuous running operation due to the problems such as tooth profile damage on the way of 3 to 800 hours running.

In addition, efficiency tests were conducted on the oscillating internal-meshing planetary gear system according to the embodiment number 1 with different reduction ratios, and the efficiency obtained was equivalent to the oscillating internal-meshing planetary gear system using the grease containing the above mentioned sodium nitrite (Albania Grease RA, manufactured by Showa Shell Sekiyu K.K.).

To summarize the above descriptions, the oscillating internal-meshing planetary gear system according to the present invention provides a long life operation, and maintains a high efficiency operation even without using the grease containing sodium nitrite. Therefore the oscillating internal-meshing planetary gear system according to the invention can be regarded as an unprecedented one from the environment protection point of view.

What is claimed is:

1. A oscillating internal-meshing planetary gear system, comprising; an external gear; and an internal gear of which the number of teeth is slightly different from said external gear, wherein:
the oscillating rotation of either said external gear or said internal gear relative to the mating gear reduces a input shaft rotation and a output reduced speed is taken off from a output shaft;
either said external gear or said internal gear has trochoidal tooth profile and the mating gear has circular-arc tooth profile; and
a space formed between said external gear and said internal gear is filled up with a grease which contains at least a base oil having kinetic viscosity being not less than 10 mm²/s at 100° C. and a lithium complex thickener synthesized from adipic acid.

2. A oscillating internal-meshing planetary gear system according to claim 1, wherein the kinetic viscosity of said base oil is not less than 50 mm²/s at 40° C.

3. A oscillating internal-meshing planetary gear system according to claim 1, wherein the kinetic viscosity of said base oil is not less than 100 mm²/s at 40° C.

4. A method for improving the durability of a oscillating internal-meshing planetary gear system, said system comprising an external gear and an internal gear of which the number of teeth is slightly different from said external gear, either said external gear or said internal gear having trochoidal tooth profile and the mating gear having circular-arc tooth profile, the oscillating rotation of either said external gear or said internal gear relative to the mating gear reducing a input shaft rotation and a output reduced speed being taken off from a output shaft, said method comprising a step of filling up a space formed between said external gear and said internal gear with a grease containinng at least a base oil having kinetic viscosity not less than 10 mm²/s at 100° C. and lithium complex thickener synthesized from adipic acid.

5. A method for improving the durability of a oscillating internal-meshing planetary gear system according to claim 4, wherein the kinetic viscosity of said base oil is not less than 50 mm²/s at 40° C.

6. A method for improving the durability of a oscillating internal-meshing planetary gear system according to claim 4, wherein the kinetic viscosity of said base oil is not less than 100 mm²/s at 40° C.
